(19) United States
(12) Patent Application Publication
(10) Pub. No.: US 2020/0008277 A1
(43) Pub. Date: Jan. 2, 2020

(54) SWITCHABLE STABILIZATION LOAD AT LOW DIMMING LEVELS

(71) Applicants: Markus Zeigler, Munich (DE); Andrew Johnsen, Sanbornton, NH (US); Satish Chandupatla, Woburn, MA (US); Yaping-Abner Liu, Shenzhen (CN)

(72) Inventors: Markus Zeigler, Munich (DE); Andrew Johnsen, Sanbornton, NH (US); Satish Chandupatla, Woburn, MA (US); Yaping-Abner Liu, Shenzhen (CN)

(21) Appl. No.: 16/456,338

(22) Filed: Jun. 28, 2019

Related U.S. Application Data
(60) Provisional application No. 62/692,367, filed on Jun. 29, 2018.

(51) Int. Cl. H05B 33/08; H02M 7/06; H02M 3/335; H02M 1/42

(52) U.S. Cl. CPC H05B 33/0818; H05B 33/0851; H02M 1/4208; H02M 3/33576; H02M 7/06

(57) ABSTRACT

A PFC flyback converter topology is disclosed. The topology can be implemented in a single-stage and is particularly useful in driving dimmable solid state light sources in lighting applications, though other applications susceptible to instability at very low loading conditions may also benefit. Stable operation is achieved over a broader range of loading using the converter topology as provided herein. In a dimmable lighting application, stable operation (e.g., flicker-free lighting) is achieved at very low dimming levels (e.g., where the load is less than 10% full load). In some topologies, a serial arrangement including a stabilization network and a switch is connected across the solid state light sources or other load. A microcontroller unit controls the duty cycle of the switch to selectively steer excess current from the solid state light sources to the stabilization circuit, at very low dimming conditions.

### CROSS-REFERENCE TO RELATED APPLICATION

The present application claims the benefit of, and the benefit of priority of, U.S. Provisional Application No. 62/692,367 filed Jun. 29, 2018, the entire contents of which are hereby incorporated by reference.

### TECHNICAL FIELD

The present invention relates to power supplies, and more specifically to power supplies for applications susceptible to instability issues at very low loading conditions, such as dimmable lighting applications.

### BACKGROUND

Recently, the use of solid-state lighting technology has grown rapidly. Due to its high efficacy, long lifetime, and improved color quality, solid state light sources, including but not limited to light emitting diodes (LEDs), have been increasingly used in both indoor and outdoor lighting applications, including those applications that allow for dimming. However, LED-based lights typically operate in conjunction with additional circuit components. For example, in a lighting system incorporating LEDs, a flyback converter is typically used to convert an alternating current (AC) mains to one or more direct current (DC) outputs. The flyback converter includes a transformer that provides electrical isolation between the input (primary side) and output (secondary side) of the converter. Such an AC-DC flyback converter may further include power factor correction (PFC). In such cases, the AC line is connected to a bridge rectifier to produce a rough DC voltage for conversion, and the primary side of the transformer is switched open when a given current level is reached (sometimes called burst mode). Thus, PFC allows for a constant average current while simultaneously allowing for more efficient operation. There are, however, a number of non-trivial issues associated with PFC converters in applications having a variable load, such as lighting applications with dimming.

### SUMMARY

A single-stage PFC flyback converter topology is disclosed. The topology is particularly useful in driving solid state light sources, such as but not limited to LEDs, in a lighting application that includes dimming. However, other applications that have a load that varies over a relatively wide range and are susceptible to instability at low loading conditions may benefit as well. As will be appreciated, the instability will manifest in different ways, depending on the load being driven. For instance, in the context of an LED lighting application with dimming, instability may manifest as light flickering at very low (dimmed) light levels; in the context of an alarm application, instability may manifest as alarm toggling at low current alarm conditions; and in the context of an audio application, instability may manifest as the sound output cutting in and out at low current audio signal conditions. In any such cases, stable operation can be achieved over a broader range of load current, using the converter topology configured with a stabilization circuit as provided herein. For instance, and continuing in the context of a dimmable lighting application, stable operation (e.g., flicker-free lighting) can be achieved at very low dimming levels (e.g., where the load across the LED is less than 10% full load). In an embodiment, the stabilization circuit includes a serial arrangement of a stabilization network and switch connected across the LEDs (or other load). A microcontroller unit (MCU) controls the duty cycle of the switch to selectively steer excess current from the LEDs (or other load) to the stabilization circuit, at very low dimming (or other low load) conditions. Excess current refers to any portion of the total output current not needed, for example, for a desired dimming level (or other desired load condition). The MCU effectively causes that portion of excess current to be diverted through the stabilization circuit, while the remaining portion is delivered to the load. Thus, while the total output current (I_{stabilization_circuit}+I_{load}) generated by the converter is relatively large and not below the threshold where instability occurs, the actual amount of current delivered to the load (Load) may be below the threshold, yet instability is avoided because the total output current is at or above the threshold. The threshold can be, for instance, a minimum total output current, such that the power converter will source at least the minimum total output current, or some higher current.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1A depicts a block diagram of an example PFC converter circuit incorporated within a lighting system, the circuit being susceptible to instability during very low dimming.

FIG. 1B depicts a schematic diagram of an example PFC converter circuit incorporated within a lighting system, the circuit being susceptible to instability during very low dimming.

FIG. 2A depicts a block diagram of an example PFC converter circuit including a stabilization circuit, according to embodiments disclosed herein.

FIG. 2B depicts a schematic diagram of an example PFC converter circuit including a stabilization circuit, according to embodiments disclosed herein.

FIGS. 3A and 3B depict graphs illustrating simulation results, according to embodiments disclosed herein.

FIG. 4 depicts a graph illustrating bench test results, according to embodiments disclosed herein.

FIG. 5 depicts a sample process for operating a PFC converter application circuit including a stabilization circuit such as shown in FIGS. 2A-B, according to embodiments disclosed herein.

### DETAILED DESCRIPTION

As used through, the phrase LED includes light emitting diodes as well as all other solid state light sources, including but not limited to OLEDs (organic light emitting diodes), PLEDs (polymer light emitting diodes), laser activated solid state light sources (e.g., LARP, microLARP, etc.), OLECs (organic light emitting compounds), and the like.

As noted above, there are a number of non-trivial issues associated with PFC AC-DC converters operating in variable load conditions, such as dimmable lighting applications. In more detail, a single-stage flyback converter can be used for AC-DC conversion in a universal input mains and LED load application. Such an application typically includes dimming of the LEDs to very low light levels. Unfortunately, existing converter designs become unstable at very low light output, especially at high mains input. The cause of the instability is believed to be due to oscillations occurring as a result of control loop response, or due to missing switching cycles stemming from lower energy demand. These destabilizing conditions arise, for instance, during burst mode of the PFC converter, in which the primary current is switched on and off in effort to improve efficiency. In any case, the flickering that results from the instability is undesirable. One way to overcome this instability is to use a two-stage AC-DC converter with a pulse width modulation (PWM) output current. This approach, however, necessitates more components, space, and cost.

Thus, and according to an embodiment of the present disclosure, in order to achieve stable operation at less than a certain percentage of full load (e.g., less than 20% of the maximum light output of an LED in some cases, or less than 10% in still other example cases), a single-stage AC-DC converter is provided that includes a stabilization circuit connected across the LEDs (or another load susceptible to instability). The stabilization circuit includes a stabilization network (e.g., one or more resistors) electrically coupled in series with a switch, along with a microcontroller unit (MCU) programmed to control the duty cycle of the switch. In particular, the MCU is configured to steer or otherwise divert excess current away from the LED so that the diverted excess current passes through the stabilization network, thereby precluding the excess current from passing through the LED. Thus, the correct output current is provided to the load. In addition, by maintaining the overall output current above a certain threshold or minimum total output current where stable converter operation is achievable, it is further possible to eliminate or otherwise reduce light flicker. As will be appreciated, the stabilization circuit effectively provides a parallel path to the LED such that the LED receives a low steady current (Load, proportional to the dimming level called for), and any excess current is diverted to the stabilization circuit (I_{stabilization_circuit}).

Numerous configurations and embodiments will be apparent in light of this disclosure. While example embodiments provided herein are in the context of a specific PFC flyback converter coupled between the AC mains and an LED-base light source, other power conversion topologies that are similarly susceptible to instabilities attributable to varying load conditions as described herein may benefit as well. For instance, a flyback converter typically operates under two prevailing control schemes—voltage mode control and current mode control (in the majority of cases, current mode control needs to be dominant for stability during operation). Both these control schemes require a feedback signal related to the output voltage to be provided the PFC controller, for operation. There are a number of ways to pass this feedback signal from the output of the secondary side to the PFC of the primary side, without defeating the desired electrical isolation between the primary side and the secondary side. One example way is to use an optocoupler to send the feedback signal to the PFC controller. A second way is to use a separate winding on an isolation transformer. A third way includes sampling the voltage on the primary side of the isolation transformer during transformer discharge and referencing the sampled voltage during discharge to the standing primary voltage. The example embodiments depicted in the figures include the optocoupler technique, but it will be appreciated that the other techniques can also be used. Likewise, the techniques provided herein can be used with any number of converter topologies, such as buck, boost, and buck-boost.

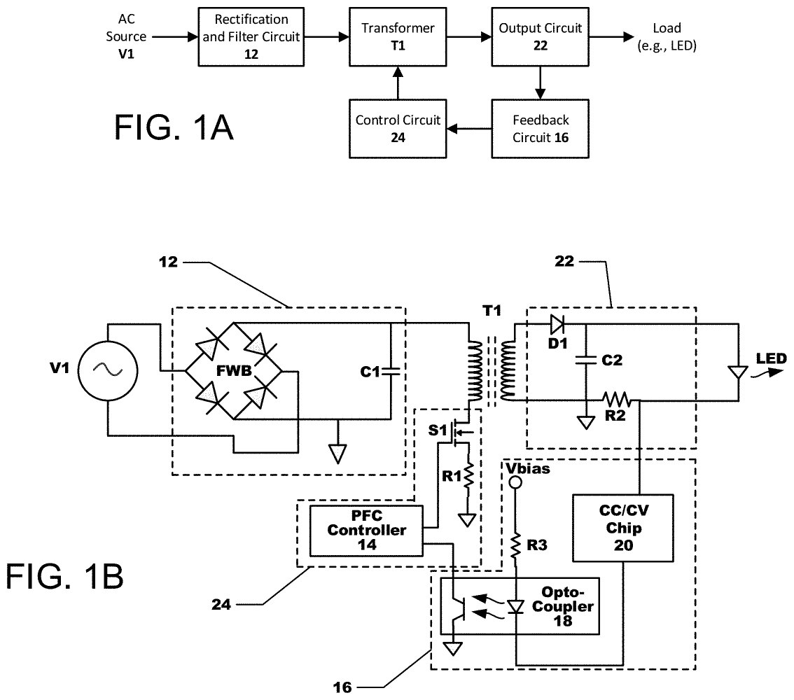

Referring to FIG. 1A, a PFC converter circuit susceptible to instability during low dimming operation is shown. As can be seen, the converter circuit of this example is coupled to an AC voltage source V1 and is driving an LED-based load, although the converter circuit can be used to drive a number of load types as will be appreciated. The converter circuit includes a transformer T1 operatively coupled between a rectification and filter circuit 12 and an output circuit 22. In addition, a feedback circuit 16 samples the output signal provided by output circuit 22, and provides that sample to control circuit 24 which selectively switches the primary of the transformer T1 to achieve a desired power factor. Each of these components can be implemented with standard circuitry.

FIG. 1B schematically illustrates one specific example such converter circuit. As can be seen in this example case, the rectification and filter circuit 12 includes a full-wave bridge (FWB) rectifier having first and second input leads connected to the AC voltage source V1, and first and second output leads. In addition, the rectification and filter circuit 12 further includes a filter or smoothing capacitor C1 across the first and second output leads of the FWB rectifier. As can be further seen, the transformer T1 has a first primary input lead connected to the first lead of the first capacitor, a second primary input lead, a first secondary output lead, and a second secondary output lead. Transformer T1 stores energy and releases energy, based on operation of the control circuit 24, which in this example case includes switch S1 controllable by the PFC controller 14, and current limiting resistor R1. Switch S1 is connected between the second primary lead of transformer T1 and resistor R1, and resistor R1 is connected between switch S1 and ground. When switch S1 is closed, transformer T1 stores energy, and when switch S1 is open, transformer T1 releases energy to output. Switch S1 can be implemented with any number of switching technologies but, in this example, switch S1 is an n-channel field effect transistor (NFET) that includes a gate, a source connected to the second primary input lead of the transformer T1, and a drain.

As can be further seen in FIG. 1B, the PFC controller 14 has an input lead and an output lead, the output lead connected to the gate of the switch S1 and the input lead connected to an optocoupler 18 of feedback circuit 16. The PFC controller 14, when dimming or otherwise lowering the output voltage/current, will adjust the switch control to control the light output of LED. The LED thus sees a DC signal. When the converter circuit is used to provide lower dimming levels (e.g., such as current signals that correspond to less than 20% of the maximum output of the LED), the PFC controller 14, and internal control loop provided by feedback circuit 16, can miss switching cycles and cause oscillations occurring as a result of control loop response, and thus becomes unstable. When the PFC controller 14 operates in such a mode, it can cause the LED to output a flickering light output.

As further shown in FIG. 1B, the output circuit 22 of this example case includes a diode D1 that has its anode connected to the first secondary output of the transformer T1 and its cathode connected to the anode of the output LED. Note that while the load is shown as one LED in this example case, a string of LEDs or even parallel strings of LEDs can be used. In still other embodiments, the load is some other load that has a wide range of current operation. A filter capacitor C2 includes a first lead connected to the cathode of the diode D1 and a second lead connected to the ground. A current limiting resistor R2 includes a first lead connected to the second secondary output of the transformer T1 and a second lead connected to the input of a feedback circuit 16.

As shown in FIG. 1B, the feedback circuit 16 includes a Constant Current/Constant Voltage (CC/CV) chip or circuit 20 having an input coupled to the second lead of resistor R2 and an output connected to optocoupler 18. The optocoupler 18 allows for isolation between the feedback circuit 16 and the control circuit 24 and has a first input connected to a biasing voltage (Vbias) via resistor R3, a second input connected to the output of the CC/CV circuit 20, a third input connected to a ground, and an output connected to the PFC controller 14.

When the switch S1 is closed, the primary of the transformer T1 is directly connected to the input voltage source V1. The primary current and magnetic flux in the transformer increases, storing energy in the transformer. The voltage induced in the secondary winding is negative, so the diode D1 is reverse-biased (i.e., and thus blocks current flow). The output capacitor C2 (e.g., an electrolytic capacitor) supplies energy to the output load during this reverse bias condition. Conversely, when the switch S1 is opened, the primary current and magnetic flux drops. The secondary voltage is positive, forward-biasing the diode D1, and allowing current to flow from the transformer. The energy from the transformer core recharges the capacitor C2 and supplies the load to the LED. However, as noted above, the design of the converter circuit can result in a flickering output at the LED at low dimming levels as a result of control provisioned by the PFC controller 14 during low power demand conditions.

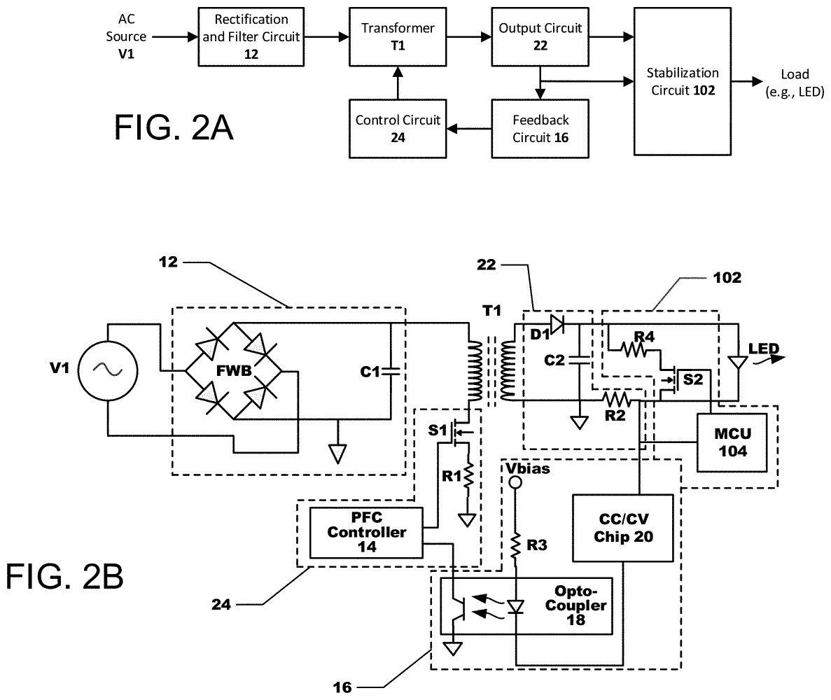

To this end, FIG. 2A provides an example PFC converter circuit including a stabilization circuit, in accordance with an embodiment of the present disclosure. The converter circuit allows for stable operation during lower power demand conditions. As can be seen, the converter circuit of this example is coupled to an AC voltage source V1 and is driving an LED-based load, although the converter circuit can be used to drive a number of load types as will be appreciated. The converter circuit includes a transformer T1 operatively coupled between a rectification and filter circuit 12 and an output circuit 22. In addition, a feedback circuit 16 samples the output signal provided by output circuit 22, and provides that sample to control circuit 24 which selectively switches the primary of the transformer T1 to achieve a desired power factor. In addition, this converter circuit further includes a stabilization circuit 102 operatively coupled between the output circuit 22 and the load.

FIG. 2B schematically illustrates an example such converter circuit, according to one specific embodiment. The previous relevant discussion with respect to the componentry shown in FIGS. 1A-B is equally applicable here. As can be seen in FIG. 2B, the converter circuit as shown in FIG. 1B has been modified to include various components to provide stabilization of the PFC controller output and the LED light output at low dimming levels. In more detail, stabilization circuit 102 is designed to achieve stable operation of the converter circuit at less than a certain percentage of full load, such as at less than 10% full load. In particular, stabilization circuit 102 of this example embodiment includes a stabilization resistor R4 connected in series with a switch S2. This serial arrangement of switch S2 and resistor R4 is connected across the load (e.g., LED(s)), so as to be electrically in parallel with the load. A microcontroller unit (MCU) 104 controls the duty cycle of the switch S2 to steer at least a portion of the LED current through resistor R4 at low dimming levels. In some examples, the switch S2 can include an NFET, although any electronic switch or switching circuitry that can be selectively closed and opened can be used. Likewise, resistor R4 may be a network of resistive elements.

For example, at very low dimming conditions (e.g., less than 20% of the maximum output of the LEDs), the duty cycle of switch S2 as controlled by microcontroller unit 104 is adjusted to steer the excess current from LED to the stabilization circuit 102. In effect, the LED will deliver very low and stable light output while burst mode or other comparably destabilizing modes of operation are prevented as, from the perspective of the PFC controller 14, a larger load is being drawn as a result of the combination of the current through the LED and the current through the resistor R1.

Example values for resistor R4 include, for instance, 100Ω, 200Ω, 500Ω, 1 kΩ, 5 kΩ, or higher. In a more general sense, the value of resistor R4 (or of a resistive network representing R4) can be selected such that current can be diverted therethrough, so as to provide a desired amount of LED current. In an example, for an expected operating current of 50 mA and lower (at low dimming levels) and an expected operating voltage of 20 V at the LED, the resistor R4 can be about 400Ω with a 2 to 5 watt rating (or better). However, it should be noted that the resistance and power rating can vary from one embodiment to the next, as will be appreciated. Similarly, the frequency for the control signal of switch S2 can vary from one embodiment to the next. For example, the frequency can be in the range of 2 kHz to 100 kHz, or higher. In some specific example embodiments, the switch S2 control signal frequency can be about 2 kHz, 5 kHz, 10 kHz, 25 kHz, or 50 kHz, although any suitable frequency can be used for the control signal of switch S2.

As will be further appreciated, the duty cycle for the control signal of switch S2 can be varied to maintain a desired average current through R4, which in turn further maintains a desired average current through the LED (or vice-versa). The duty cycle can be expressed as a percentage of the control signal period that the high level of the signal is maintained for a given period, or as ratio of the high portion to the low portion for a given period of the control signal. For instance, in one example embodiment, a 2 kHz control signal having a duty cycle of 80% (or 80:20, in the ratio format) has a period of 500 microseconds (μsec), wherein the high level is maintained for 400 μsec and the low level is maintained for 100 μsec. Note that the high level corresponds to when the switch S2 is closed (and a portion of the power converter's total output current is flowing through R4), and the low level corresponds to when the switch S2 is open (and no current is flowing through R4).

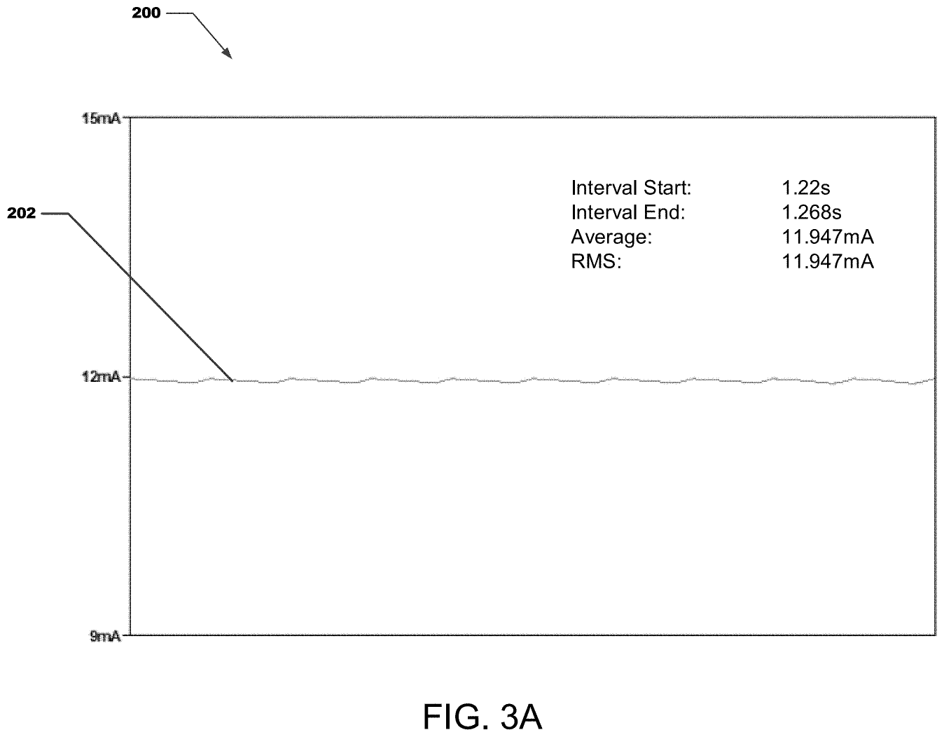

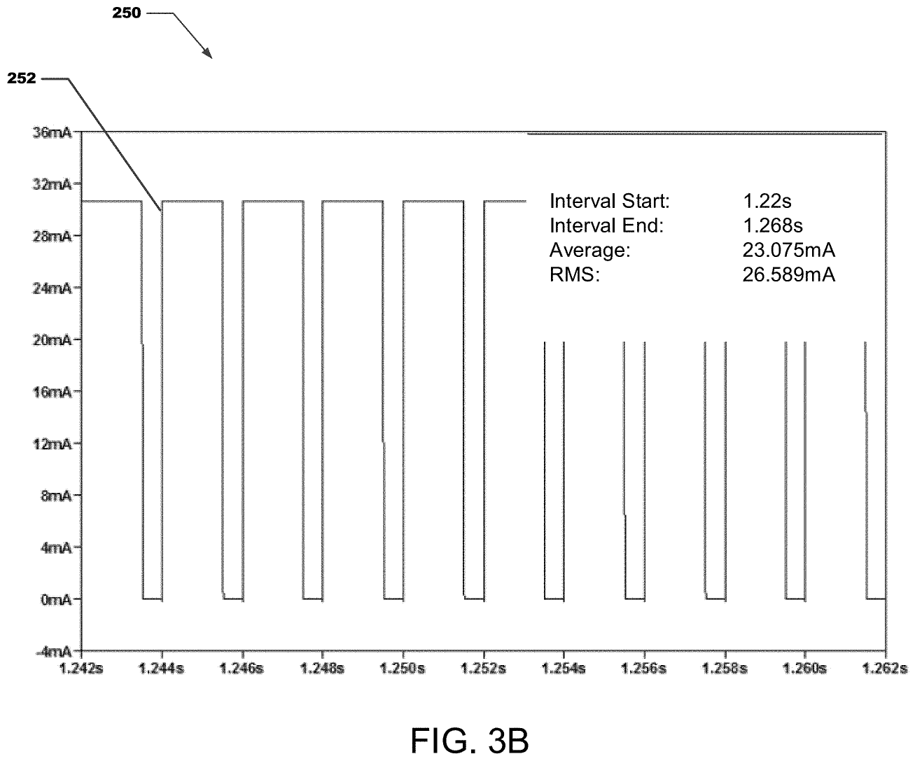

FIG. 3A depicts a graph 200 showing the results of a simulation of the circuit of FIG. 2B. A 75% duty cycle (e.g., 75:25, or 75% S2 on and 25% S2 off) was selected for simulating the microcontroller 104 driving switch S2 for the purpose of simulation using a 2 kHz operational switching frequency. A current of 35 milliamperes (mA) is split between the load (LED) and the stabilization circuit 102. The average LED current 202 through the LED is measured as 11.93 mA. As can be seen by the waveform 202, a near-constant waveform is produced, thus indicating that a near-constant LED current is being delivered to the LED, thereby reducing or eliminating any flickering caused by fluctuations in LED current at low dimming levels.

FIG. 3B depicts a graph 250 showing the average current 252 through resistor R4 of the stabilization circuit 102, which is measured as an average 23.075 mA current. As can be seen by the waveform 252, a very regulated and repeatable square wave waveform is produced as a result of the 75% duty cycle as simulated as the output of the microcontroller 104 for controlling switch S2. Thus, from the perspective of the PFC controller 14, the total current being delivered to the load is about 35 mA, when in actuality the load is only seeing about a third (˜11.93 mA) of that current.

Note that the MCU 104 can be programmed or otherwise configured to know the minimum current that can be delivered to the load without inducing burst mode or other low power modes that are susceptible to instability. With this minimum current threshold known by the MCU 104, as well as the current associated with a known dimming level, then the amount of the current to be diverted to the stabilization circuit can be readily computed (current divider rule) by the MCU 104. The MCU 104 can further determine the duty cycle of the S2 control signal that will manifest that current split.

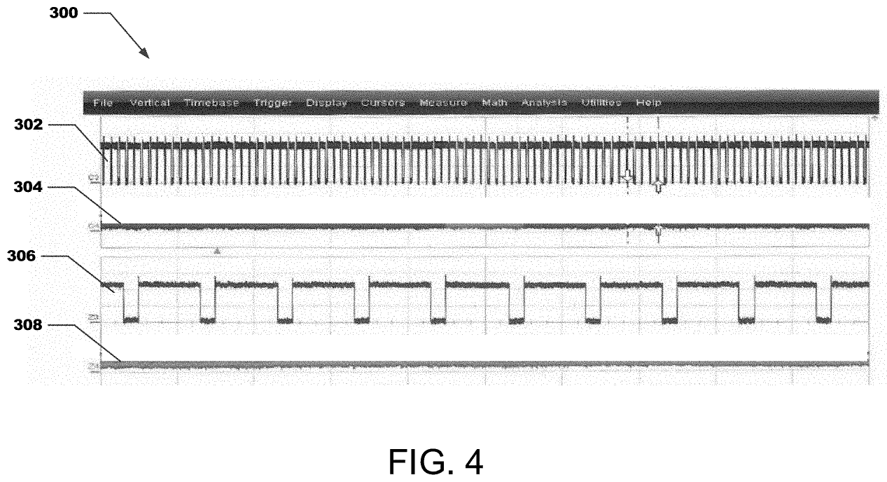

Referring now to FIG. 4, a graph 300 of the results of a bench test of the circuit of FIG. 2 shows four waveforms. Waveform 302 is the current through the stabilization resistor R1 which confirms the operation of the circuit. Waveform 304 is the current through the LED which is constant. Waveform 306 is a magnified view of waveform 302, while waveform 308 is a magnified view of waveform 304.

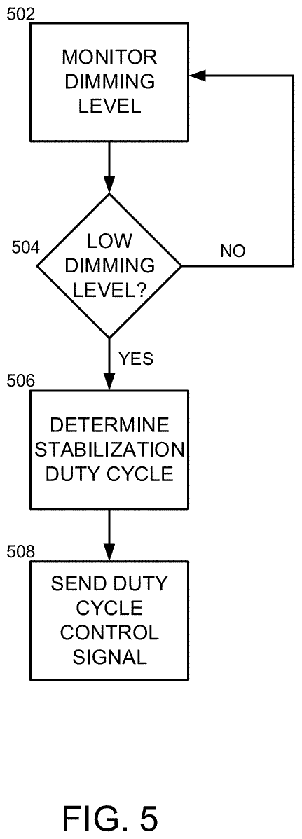

FIG. 5 depicts a sample process as performed by a microcontroller such as MCU 104 as shown in FIG. 2B and described above. As shown in FIG. 5, the microcontroller can monitor 502 a dimming level control signal provided, for example, as an input to a lighting control circuit such as the lighting control circuit as shown in FIGS. 2A and 2B. The dimming level control signal can be generated by, for example, an in-wall digital light dimming switch or some other dimming control circuit. The microcontroller can determine 504 if the diming level is at a certain threshold defined as a low dimming level. For example, as noted above, a low dimming level can be a dimming level where the output of the PFC controller can cause flickering of an LED's output light. As noted herein, the low dimming level can be at a certain percentage of the maximum output of the LED. For example, the low diming level can be at 20% of the maximum output of the LED. However, it should be noted that 20% is used herein by way of example only. In certain examples, the low dimming level can be at 15% of the maximum output of the LED, at 25% of the maximum output of the LED, at 30% of the maximum output of the LED, and some other percentage of the maximum output of the LED where a particular power converter may enter burst mode as described herein.

Referring back to FIG. 5, if the microcontroller determines 504 that the dimming level is not set to a low level, the microcontroller can continue to monitor 502 the dimming level. In such cases, note that the stabilization circuit need not be engaged. However, if the microcontroller does determine 504 that the dimming level is below the low dimming level threshold, the microcontroller can determine 506 a stabilization duty cycle for controlling a switch in a stabilization circuit (e.g., switch S2 in stabilization circuit 102 as shown in FIG. 2B). For example, the microcontroller can determine a duty cycle based upon the requested dimming level and the known minimum total output current that will avoid unstable power converter operation. Note that the requested dimming level equates to a desired LED current, and the known minimum total output current can be used to compute the portion of the total output current to be diverted from the LED.

With these desired currents in hand, the microcontroller can compute the duty cycle to cause delivery of the desired currents. According to one embodiment, the duty cycle is computed as follows: Duty Cycle=((I_{TOT_MIN}−I_{LED})/I_{TOT_MIN}), where I_{TOT_MIN} is the total minimum output current generated by the converter to maintain stable operation (e.g., avoid burst mode), and I_{LED} is the portion of the total current passing through the LED to achieve the desired dimming level. Further note that the current through the stabilization network (R4) is I_{TOT_MIN}−I_{LED}. Thus, in this example embodiment, the duty cycle is based on a ratio of the current through the stabilization network (R4) to the total output current generated by the converter. The longer the duration that the switch is closed (which corresponds to the high portion of the control signal period), the higher the average current through the stabilization network (R4) and the lower the average current through the LED; conversely, the longer the duration that the switch is open (which corresponds to the low portion of the control signal period), the lower the average current through the stabilization network (R4) and the higher the average current through the LED. As will be appreciated, the MCU can thus readily compute a duty cycle that will deliver a first portion of the total minimum output current to the LED (to provide the requested dimming level), and deliver a second (remaining or excess) portion of the total minimum output current to the stabilization network.

The duty cycle determination can be done in real-time by a processor included in the microcontroller, according to some embodiments. In other embodiments, a look-up table (LUT) is provided in memory of the microcontroller, or is otherwise made accessible to the microcontroller. In such cases, the look-up table can be populated with duty cycles indexed by requested LED current, such as the example use case shown in Table 1 below.

TABLE 1

| Desired LED Current | Duty Cycle |
|---|---|
| 1 mA | 95% |
| 2 mA | 93% |
| 3 mA | 90% |
| 4 mA | 87% |
| 5 mA | 85% |
| 6 mA | 82% |
| 7 mA | 80% |
| 8 mA | 77% |
| 9 mA | 75% |
| 10 mA | 72% |
| . . . | . . . |
| 25 mA | 55% |

So, given a dimming level request associated with a particular LED current, the LUT can be consulted to identify the control signal duty cycle that will deliver that desired LED current. The microcontroller can then cause delivery of that control signal having the identified duty cycle to the stabilization circuit switch (S2). The LUT can be populated, for instance, using empirical data that is actually measured for given load conditions, and/or using theoretical data that is computed (e.g., based on circuit analysis or simulation results). Note that once the LED current is above the total minimum output current, which is 25 mA in this particular example embodiment, the stabilization circuit need not be engaged.

In any such cases, and with further reference to FIG. 5, based upon the duty cycle determination at 506, the microcontroller can output 508 a control signal to the switch (S2) in the stabilization circuit, with that control signal having the determined duty cycle that causes delivery of the correct load current to the LED and further causes diversion of any excess output current through a resistor (or resistive network) in the stabilization circuit (e.g., resistor R4 as shown in FIG. 2B). Thus, the duty cycle of the control signal effectively defines a first portion of the output signal that flows through the resistive network of the stabilization circuit and a second (remaining or excess with respect to the minimum output converter current) portion of the output signal that flows through the LED or load. The duty cycle can vary from one example to the next, but in some example embodiments is in the range of 95:5 to 5:95 (e.g., 95% S2 on and 5% S2 off, to 5% S2 on and 95% S2 off). In any such example cases, the proper dimming level current can be delivered to the LED load, while the overall total current is maintained in the stable range of the given power converter design, so flicker (or some other manifestation of unstable very low-load current operation) is avoided.

The following examples pertain to further embodiments, from which numerous permutations and configurations will be apparent.

Example 1 includes a power converter for driving a variable load. The power converter includes a rectification and filter circuit for rectifying and filtering an AC input signal, an output circuit for outputting a DC output signal, a transformer having a primary coil operatively coupled to the rectification and filter circuit and a secondary coil operatively coupled to the output circuit, a feedback circuit operatively coupled to the secondary coil and configured to sample the DC output signal output by the output circuit, a control circuit to selectively open the primary coil of the transformer based on the DC output signal sampled by the feedback circuit, and a stabilization circuit including a microcontroller unit and a serial arrangement including a resistor and a switch, the serial arrangement for coupling in parallel to a load being driven by the converter, and the microcontroller unit to control a duty cycle of the switch to selectively steer a first portion of the output signal from the load to the resistor, thereby leaving a second portion of the output signal to flow through the load.

Example 2 includes the subject matter of Example 1, wherein the variable load includes an LED.

Example 3 includes the subject matter of Example 2, wherein the microcontroller unit is configured to control the duty cycle of the switch during low dimming operation of the LED.

Example 4 includes the subject matter of Example 3, wherein the low dimming operation of the LED includes operating the LED at less than twenty percent of its maximum output.

Example 5 includes the subject matter of any of Examples 2-4, wherein the microcontroller unit is configured to control the duty cycle of the switch to prevent flickering of the LED during low dimming operation of the LED.

Example 6 includes the subject matter of any of the preceding Examples, wherein the microcontroller unit is configured to control the duty cycle of the switch by outputting a control signal to the switch during low load current operation, wherein the control signal has a duty cycle that defines the first portion of the output signal to flow through the resistor and the second portion of the output signal to flow through the load.

Example 7 includes the subject matter of Example 6, and further includes the load, wherein the load includes an LED.

Example 8 includes the subject matter of any of the preceding Examples, wherein the switch of the stabilization network is a first switch, and wherein the feedback circuit includes an optocoupler configured to pass the DC output signal sampled by the feedback circuit to the control circuit, and wherein the control circuit includes a PFC controller operatively coupled to a second switch to selectively open the primary coil of the transformer based on the DC output signal sampled by the feedback circuit.

Example 9 includes a method of operating an LED at low dimming operation, the LED being driven by a power converter. The method includes receiving, by a processor, a dimming level control signal; determining, by the processor, if the dimming level control signal indicates the LED is to be operated at low dimming operation; and, if the processor determines the LED is to be operated at low dimming operation, determining, by the processor, a duty cycle of a control signal for operating a switch in a stabilization circuit, the stabilization circuit in parallel to the LED and causing, by the processor, transmission of the control signal to the switch, thereby causing a first portion of total power converter output current to pass through the stabilization circuit, and further causing a second portion of the total converter output current to flow through the LED, the second portion of the total power converter output current corresponding to a dimming level associated with the dimming level control signal.

Example 10 includes the subject matter of Example 9, wherein determining if the dimming control signal indicates the LED is to be operated at low dimming operation includes comparing, by the processor, the dimming control signal to a threshold value for low dimming operation.

Example 11 includes the subject matter of Example 9 or 10, wherein the low dimming operation of the LED includes operating the LED at less than twenty percent of its maximum output.

Example 12 includes the subject matter of any of Examples 9-11, wherein the stabilization circuit includes a serial arrangement including at least one resistor and the switch.

Example 13 includes the subject matter of any of Examples 9-12, wherein the control signal includes a switching frequency of at least 2.0 kHz, and the duty cycle of the control signal is in the range of 95:5 to 5:95.

Example 14 includes a lighting system including a single-stage power converter circuit including an input stage for receiving a source voltage, and an output stage for outputting an output current, a light emitting diode (LED), and a lighting stability circuit operatively coupled between the LED and the output stage of the power converter circuit. The lighting stability circuit includes a resistor, a switch operably coupled in series with the resistor, the resistor and the switch being connected in parallel with the LED, and a microcontroller operably coupled to the switch and configured to determine a dimming level of the LED during operation of the lighting system and control operation of the switch to selectively divide the output current between the resistor and the LED during low dimming operation of the LED.

Example 15 includes the subject matter of Example 14, wherein the single-stage power converter circuit is a flyback converter circuit.

Example 16 includes the subject matter of Example 15, wherein the flyback converter circuit includes a power factor correction (PFC) controller configured to control operation of a transformer to provide the output current to the lighting stability circuit and the LED.

Example 17 includes the subject matter of Example 16, wherein the lighting system further includes a feedback circuit operably coupled between the output circuit and the PFC controller.

Example 18 includes the subject matter of Example 17, wherein the feedback circuit includes a CC/CV circuit and an optocoupler operably coupled to the CC/CV circuit and configured to supply a control signal based upon an output of the CC/CV circuit to the PFC controller to control operation of the transformer.

Example 19 includes the subject matter of any of Examples 14-18, wherein the switch includes a Field Effect Transistor (FET).

Example 20 includes the subject matter of any of Examples 14-19, wherein the low dimming operation of the LED includes operating the LED at less than twenty percent of its maximum output.

Example 21 includes a computer program product including one or more non-transitory machine-readable mediums encoded with instructions that when executed by one or more processors cause a process to be carried out for operating a single-stage power converter during a low load condition, the single-stage power converter including a stabilization circuit, the stabilization circuit for coupling in parallel to the load. The process includes determining a duty cycle of a control signal for operating a switch in the stabilization circuit and causing transmission of the control signal to the switch, thereby causing a first portion of total power converter output current to pass through the stabilization circuit, and further causing a second portion of the total converter output current to flow through the load. The non-transitory medium can be any type of physical memory, such as ROM, RAM, disc drive, hard-drive, on-board cache, solid state memory, etc.

Example 22 includes the subject matter of Example 21, wherein the load is an LED and the second portion of the total power converter output current corresponds to a requested dimming level.

Example 23 includes the subject matter of Example 21 or 22, wherein determining the duty cycle of the control signal includes determining the first portion of total power converter output current to pass through the stabilization circuit by subtracting the second portion of the total converter output current from a minimum total output current, wherein the minimum total output current is pre-established, and wherein the second portion of the total converter output current is based on a request that triggered the low load condition, and wherein the duty cycle of the control signal is based on a ratio of voltage or current across the stabilization circuit to voltage or current across the load.

Example 24 is a microcontroller unit including the computer program product of any of Examples 21-23.

Example 25 is a single-stage power converter including the microcontroller unit of Example 24.

Example 26 is a single-stage power converter including the computer program product of any of Examples 21-23.

Example 27 is a microcontroller unit (MCU) for controlling a single-stage power converter during a low load condition, the single-stage power converter including a stabilization circuit, the stabilization circuit for coupling in parallel to the load, the MCU configured to: determine a duty cycle of a control signal for operating a switch in the stabilization circuit; and cause transmission of the control signal to the switch, thereby causing a first portion of total power converter output current to pass through the stabilization circuit, and further causing a second portion of the total converter output current to flow through the load. Note that the MCU may include, for instance, one or more processors, memory, input and output ports, drivers, amplifiers, filters, and/or other circuitry that is helpful to a given application. Numerous MCU configurations can be used, as will be appreciated.

Example 28 includes the subject matter of Example 27, wherein the load is an LED and the second portion of the total power converter output current corresponds to a requested dimming level.

Example 29 includes the subject matter of Example 27 or 28, wherein the MCU determines the duty cycle of the control signal by: determining the first portion of total power converter output current to pass through the stabilization circuit, by subtracting the second portion of the total converter output current from a minimum total output current, wherein the minimum total output current is pre-established, and wherein the second portion of the total converter output current is based on a request that triggered the low load condition; wherein the duty cycle of the control signal is based on a ratio of current through the stabilization circuit to minimum total output current.

Example 30 is a single-stage power converter including the microcontroller unit of any of Examples 27-29.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, Blu-Ray, magnetic disk, internal hard drive, external hard drive, memory stick, flash drive, solid state memory device, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s), handheld device(s) such as cellular telephone(s) or smartphone(s) or tablet(s), laptop(s), laptop/tablet hybrid(s), handheld computer(s), smart watch(es), or any another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A power converter for driving a variable load, the power converter comprising:
a rectification and filter circuit to rectify and filter an alternating current (AC) input signal;
an output circuit to output a direct current (DC) output signal;
a transformer comprising a primary coil operatively coupled to the rectification and filter circuit, and a secondary coil operatively coupled to the output circuit;
a feedback circuit operatively coupled to the secondary coil and configured to sample the DC output signal output by the output circuit;
a control circuit to selectively open the primary coil of the transformer based on the DC output signal sampled by the feedback circuit; and
a stabilization circuit including a microcontroller unit and a serial arrangement including a resistor and a switch, the serial arrangement to couple in parallel to a load being driven by the converter, and the microcontroller unit to control a duty cycle of the switch to selectively steer a first portion of the output signal from the load to the resistor, thereby leaving a second portion of the output signal to flow through the load.

2. The power converter of claim 1, wherein the variable load comprises a solid state light source, and wherein the microcontroller unit is configured to control the duty cycle of the switch during low dimming operation of the solid state light source.

3. The power converter of claim 2, wherein the low dimming operation of the solid state light source comprises operation of the solid state light source at less than twenty percent of its maximum output.

4. The power converter of claim 2, wherein the microcontroller unit is configured to control the duty cycle of the switch to prevent flickering of the solid state light source during low dimming operation of the solid state light source.

5. The power converter of claim 1, wherein microcontroller unit is configured to control the duty cycle of the switch by outputting a control signal to the switch during low load current operation, wherein the control signal comprises a duty cycle that defines the first portion of the output signal to flow through the resistor and the second portion of the output signal to flow through the load.

6. The power converter of claim 1, wherein the switch of the stabilization network is a first switch, and wherein the feedback circuit comprises an optocoupler configured to pass the DC output signal sampled by the feedback circuit to the control circuit, and wherein the control circuit comprises a power factor correction (PFC) controller operatively coupled to a second switch to selectively open the primary coil of the transformer based on the DC output signal sampled by the feedback circuit.

7. A method comprising:
receiving, by a processor, a dimming level control signal;
determining, by the processor, if the dimming level control signal indicates a solid state light source is to be operated at low dimming operation; and
if the processor determines the solid state light source is to be operated at low dimming operation:
determining, by the processor, a duty cycle of a control signal to operate a switch in a stabilization circuit, the stabilization circuit in parallel to the solid state light source; and
causing, by the processor, transmission of the control signal to the switch, thereby causing a first portion of total power converter output current to pass through the stabilization circuit, and further causing a second portion of the total converter output current to flow through the solid state light source, the second portion of the total power converter output current corresponding to a dimming level associated with the dimming level control signal.

8. The method of claim 7, wherein determining if the dimming control signal indicates the solid state light source is to be operated at low dimming operation comprises comparing, by the processor, the dimming control signal to a threshold value for low dimming operation.

9. The method of claim 7, wherein the low dimming operation of the solid state light source comprises operating the solid state light source at less than twenty percent of its maximum output.

10. The method of claim 7, wherein the stabilization circuit includes a serial arrangement including at least one resistor and the switch.

11. The method of claim 7, wherein the control signal comprises a switching frequency of at least 2.0 kHz, and the duty cycle of the control signal is in the range of 95:5 to 5:95.

12. A lighting system comprising:
a single-stage power converter circuit comprising an input stage to receive a source voltage, and an output stage to output an output current;
a solid state light source; and
a lighting stability circuit operatively coupled between the solid state light source and the output stage of the power converter circuit, the lighting stability circuit comprising:
a resistor;
a switch operably coupled in series with the resistor, the resistor and the switch being connected in parallel with the solid state light source; and
a microcontroller operably coupled to the switch and configured to determine a dimming level of the solid state light source during operation of the lighting system, and to control operation of the switch to selectively divide the output current between the resistor and the solid state light source during low dimming operation of the solid state light source.

13. The lighting system of claim 12, wherein the single-stage power converter circuit is a flyback converter circuit, and wherein the flyback converter circuit comprises a power factor correction (PFC) controller configured to control operation of a transformer to provide the output current to the lighting stability circuit and the solid state light source.

14. The lighting system of claim 13, further comprising a feedback circuit operably coupled between the output circuit and the PFC controller.

15. The lighting system of claim 14, wherein the feedback circuit comprises:
a Constant Current/Constant Voltage (CC/CV) circuit; and
an optocoupler operably coupled to the CC/CV circuit and configured to supply a control signal based upon an output of the CC/CV circuit to the PFC controller to control operation of the transformer.

16. A computer program product including one or more non-transitory machine-readable mediums encoded with instructions that, when executed by one or more processors, cause a process to be carried out to operate a single-stage power converter during a low load condition, the single-stage power converter including a stabilization circuit, the stabilization circuit to couple in parallel to the load, the process comprising:
determining a duty cycle of a control signal to operate a switch in the stabilization circuit; and
causing transmission of the control signal to the switch, thereby causing a first portion of total power converter output current to pass through the stabilization circuit, and further causing a second portion of the total converter output current to flow through the load.

17. The computer program product of claim 16, wherein the load is a solid state light source and the second portion of the total power converter output current corresponds to a requested dimming level.

18. The computer program product of claim 16, wherein determining the duty cycle of the control signal comprises:
determining the first portion of total power converter output current to pass through the stabilization circuit, by subtracting the second portion of the total converter output current from a minimum total output current, wherein the minimum total output current is pre-established, and wherein the second portion of the total converter output current is based on a request that triggered the low load condition;
wherein the duty cycle of the control signal is based on a ratio of current through the stabilization circuit to minimum total output current.

19. A microcontroller unit (MCU) to controlling a single-stage power converter during a low load condition, the single-stage power converter including a stabilization circuit, the stabilization circuit to couple in parallel to the load, the MCU configured to:
determine a duty cycle of a control signal for operating a switch in the stabilization circuit; and
cause transmission of the control signal to the switch, thereby causing a first portion of total power converter output current to pass through the stabilization circuit, and further causing a second portion of the total converter output current to flow through the load.

20. The MCU of claim 19, wherein the load is a solid state light source and the second portion of the total power converter output current corresponds to a requested dimming level.

21. The MCU of claim 19, wherein the MCU determines the duty cycle of the control signal by:
determining the first portion of total power converter output current to pass through the stabilization circuit, by subtracting the second portion of the total converter output current from a minimum total output current, wherein the minimum total output current is pre-established, and wherein the second portion of the total converter output current is based on a request that triggered the low load condition;
wherein the duty cycle of the control signal is based on a ratio of current through the stabilization circuit to minimum total output current.
